(19) United States
(12) Patent Application Publication
(10) Pub. No.: US 2014/0310636 A1
(43) Pub. Date: Oct. 16, 2014

(54) USER INTERFACE METHOD AND APPARATUS FOR PROVIDING DEFORMATION-SENSITIVE INPUT

(71) Applicants: Juha Arrasvuori, Tampere (FI); Kong Qiao Wang, Helsinki (FI); Erika Piia Pauliina Reponen, Tampere (FI)

(72) Inventors: Juha Arrasvuori, Tampere (FI); Kong Qiao Wang, Helsinki (FI); Erika Piia Pauliina Reponen, Tampere (FI)

(73) Assignee: NOKIA CORPORATION, Espoo (FI)

(21) Appl. No.: 14/357,444

(22) PCT Filed: Nov. 11, 2011
(86) PCT No.: PCT/IB2011/055045

§ 371 Date: May 9, 2014

(51) Int. Cl. G06F 3/0484; G06F 3/0482

(52) U.S. Cl. CPC G06F 3/0484; G06F 3/0482
USPC 715/771

(57) ABSTRACT

A method, apparatus, computer program and user interface wherein the method comprises detecting a user input wherein the user input comprises deforming at least a portion of a housing of an apparatus; and in response to detecting the user input, varying the amount of content displayed on a display, in dependence upon the deformation made to the housing of the apparatus.

### TECHNOLOGICAL FIELD

Embodiments of the present disclosure relate to a method, apparatus, computer program and user interface. In particular, they relate to a method, apparatus, computer program and user interface where the apparatus comprises a housing which can be deformed by being bent or stretched by the user of the apparatus.

### BACKGROUND

Apparatus which display content such as information or user selectable items are well known. It is useful to provide a simple and intuitive way of enabling a user of such apparatus to control the content which is displayed on the display.

### BRIEF SUMMARY

According to various, but not necessarily all, embodiments of the disclosure there is provided a method comprising: detecting a user input wherein the user input comprises deforming at least a portion of a housing of an apparatus; and in response to detecting the user input, varying the amount of content displayed on a display, in dependence upon the deformation made to the housing of the apparatus.

In some embodiments the housing may comprise an external casing of the apparatus.

In some embodiments the user input may comprise applying stress to the housing of the apparatus to cause the deformation.

In some embodiments the deformation may comprise bending at least a portion of the housing of the apparatus.

In some embodiments the deformation may comprise stretching at least a portion of the housing of the apparatus.

In some embodiments, in response to detecting a first deformation, content may be added to the display. In response to detecting a second, different deformation content may be removed from the display.

In some embodiments the amount of content added or removed may be dependent upon a magnitude of the deformation.

In some embodiments returning the apparatus to an un-deformed state may cause content displayed on the display to be returned to an original state.

In some embodiments the method may further comprise controlling the display to fix the content displayed on the display so that returning the apparatus to an un-deformed state does not cause any further change in the content displayed on the display.

In some embodiments varying the amount of content displayed on the display may comprise varying the number of user selectable control elements displayed on the display.

In some embodiments varying the amount of content displayed may comprise displaying metadata associated with an item displayed on a display.

In some embodiments varying the amount of content may comprise varying the number of items displayed in a list.

In some embodiments varying the amount of content may comprise displaying additional information associated with items in a list.

In some embodiments the content which is added or removed from the display may comprise content which is associated with content displayed on the display before the user input is detected.

According to various, but not necessarily all, embodiments of the disclosure there is provided an apparatus comprising: at least one processor; and at least one memory including computer program code; wherein the at least one memory and the computer program code are configured to, with the at least one processor, enable the apparatus to: detect a user input wherein the user input comprises deforming at least a portion of a housing of the apparatus; and in response to detecting the user input, vary the amount of content displayed on a display, in dependence upon the deformation made to the housing of the apparatus.

In some embodiments the housing may comprise an external casing of the apparatus.

In some embodiments wherein the user input may comprise applying stress to the housing of the apparatus to cause the deformation.

In some embodiments the deformation may comprise bending at least a portion of the housing of the apparatus.

In some embodiments the deformation may comprise stretching at least a portion of the housing of the apparatus.

In some embodiments the at least one memory and the computer program code may be configured to, with the at least one processor, enable the apparatus to, add content to the display in response to detecting a first deformation. The at least one memory and the computer program code may also be configured to, with the at least one processor, enable the apparatus to, remove content from the display in response to detecting a second, different deformation.

In some embodiments the amount of content added or removed may be dependent upon a magnitude of the deformation.

In some embodiments the at least one memory and the computer program code may be configured to, with the at least one processor, cause content displayed on the display to be returned to an original state in response to detecting that the apparatus is returned to an un-deformed state.

In some embodiments the at least one memory and the computer program code may be configured to, with the at least one processor, enable the apparatus to control the display to fix the content displayed on the display so that detecting the apparatus has returned to an un-deformed state does not cause any further change in the content displayed on the display.

In some embodiments varying the amount of content displayed on the display may comprise varying the number of user selectable control elements displayed on the display.

In some embodiments varying the amount of content displayed may comprise displaying metadata associated with an item displayed on a display.

In some embodiments varying the amount of content may comprise varying the number of items displayed in a list.

In some embodiments varying the amount of content may comprise displaying additional information associated with items in a list.

In some embodiments content which is added or removed from the display may comprise content which is associated with content displayed on the display before the user input is detected.

According to various, but not necessarily all, embodiments of the disclosure there is provided an apparatus comprising: means for detecting a user input wherein the user input comprises deforming at least a portion of a housing of an apparatus; and means for varying, in response to detecting the user input, the amount of content displayed on a display, in dependence upon the deformation made to the housing of the apparatus.

According to various, but not necessarily all, embodiments of the disclosure there is provided a computer program comprising computer program instructions that, when executed by at least one processor, cause an apparatus at least to perform: detecting a user input wherein the user input comprises deforming at least a portion of a housing of an apparatus; and in response to detecting the user input, varying the amount of content displayed on a display, in dependence upon the deformation made to the housing of the apparatus.

In some embodiments there is provided a computer program comprising program instructions for causing a computer to perform the method of any of the above paragraphs.

In some embodiments there is provided a physical entity embodying the computer program as described above.

In some embodiments there is provided an electromagnetic carrier signal carrying the computer program as described above.

According to various, but not necessarily all, embodiments of the disclosure there is provided a user interface comprising: a user input device configured to detect a user input wherein the user input comprises deforming at least a portion of a housing of an apparatus; and a display, wherein, in response to detecting the user input comprising deforming at least a portion of a housing of an apparatus, the amount of content displayed on the display is varied, in dependence upon the deformation made to the housing of the apparatus.

In some embodiments the housing may comprise an external casing of the apparatus.

In some embodiments in response to detecting a first deformation content is added to the display. In response to detecting a second, different deformation content is removed from the display.

The apparatus may be for wireless communication

### BRIEF DESCRIPTION

For a better understanding of various examples of embodiments of the present disclosure reference will now be made by way of example only to the accompanying drawings in which:

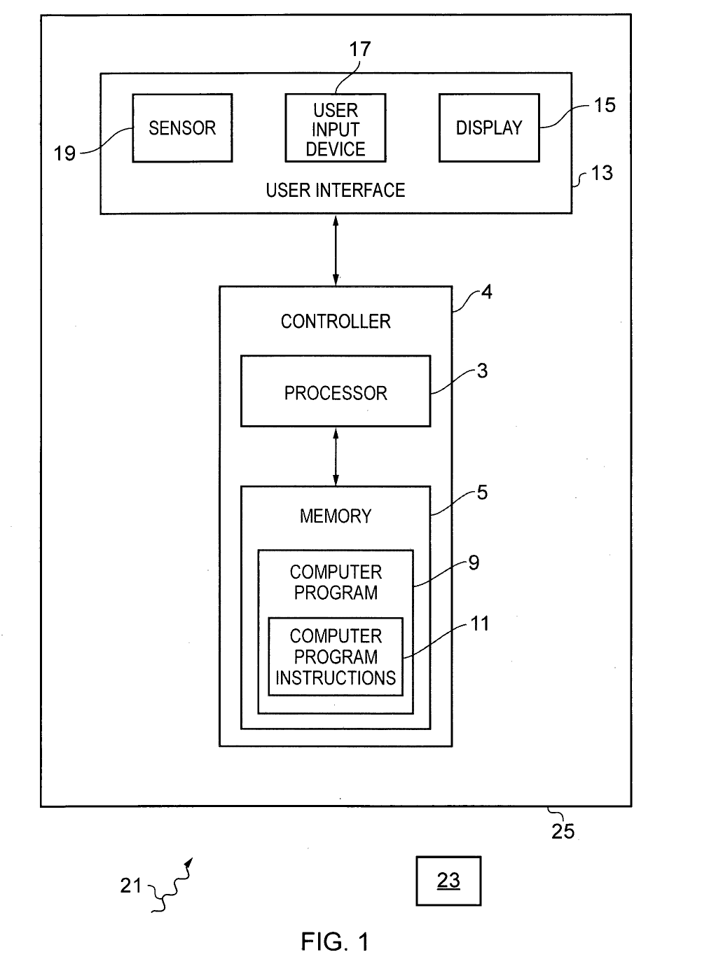

FIG. 1 schematically illustrates an apparatus according to exemplary embodiments of the disclosure;

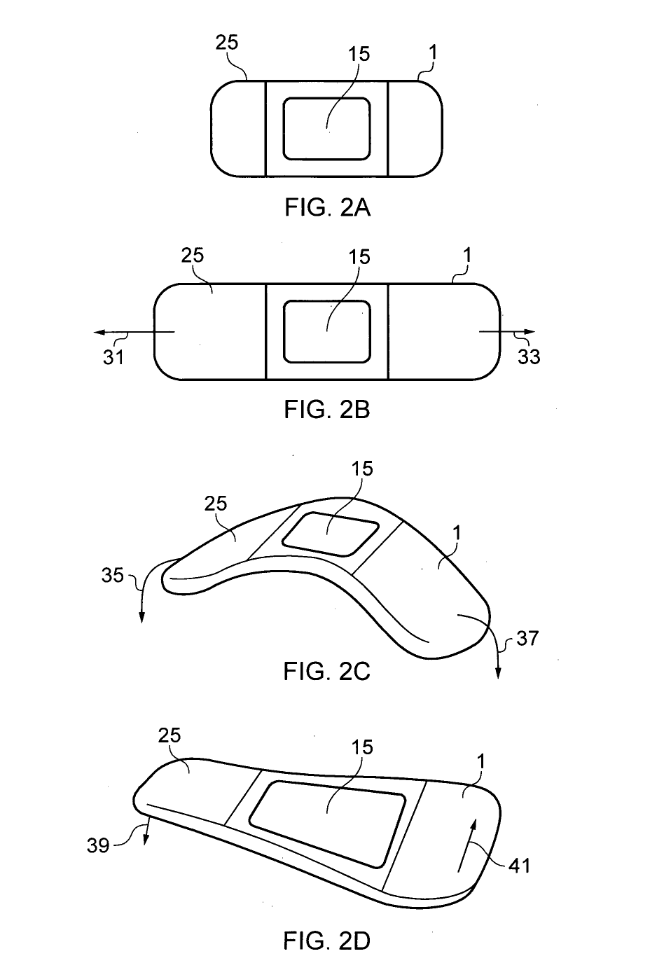

FIGS. 2A to 2D illustrate the housing of the apparatus according to exemplary embodiments of the disclosure;

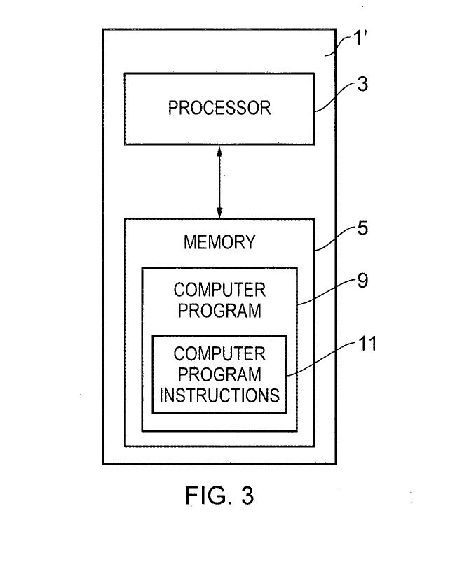

FIG. 3 schematically illustrates another apparatus according to exemplary embodiments of the disclosure;

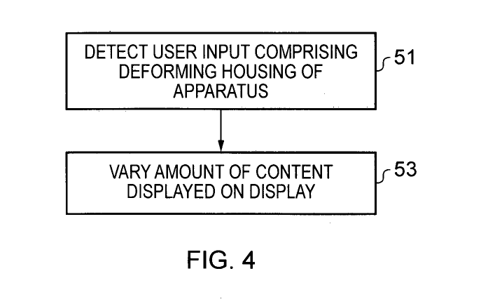

FIG. 4 is a block diagram which illustrates a method according to embodiments of the disclosure;

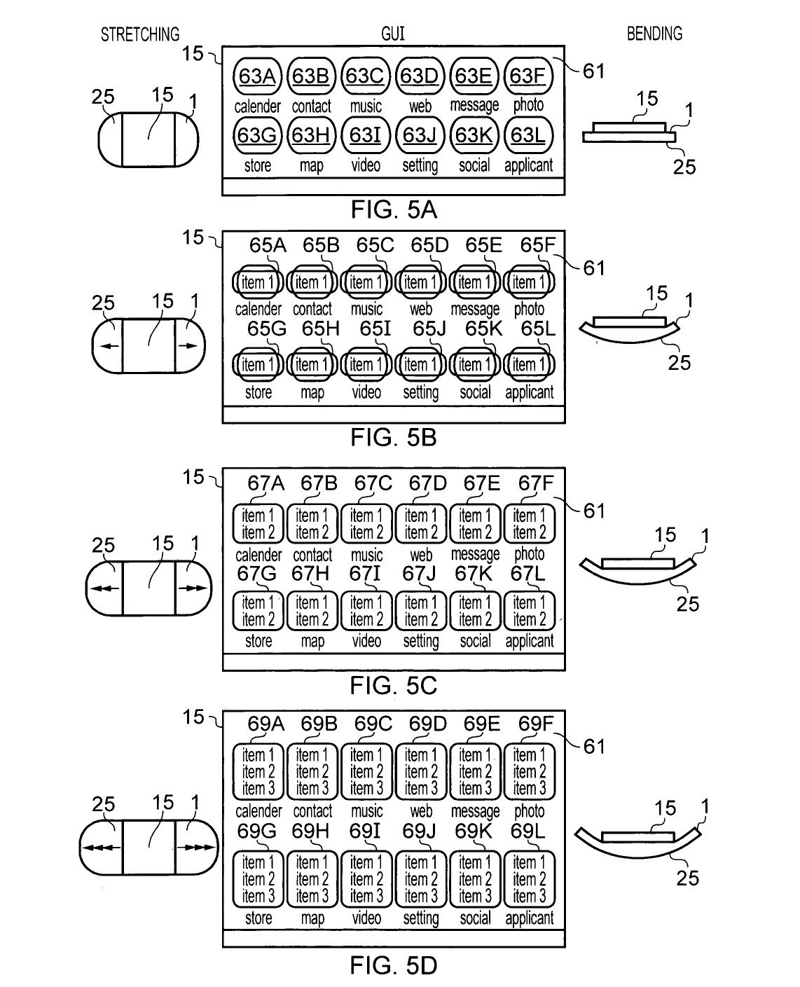

FIGS. 5A to 5D illustrate a first exemplary embodiment of the disclosure;

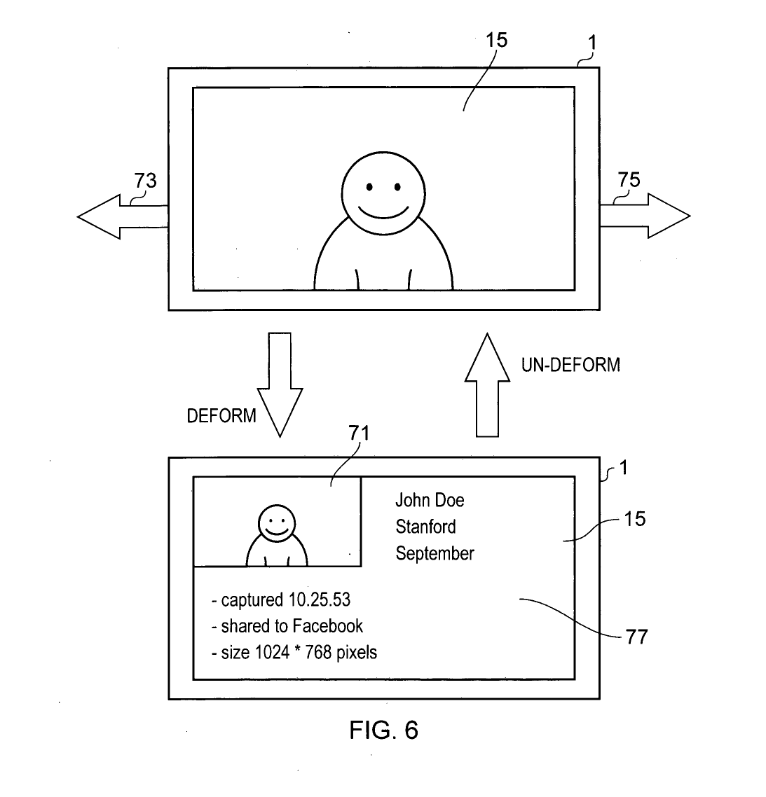

FIG. 6 illustrates a second exemplary embodiment of the disclosure;

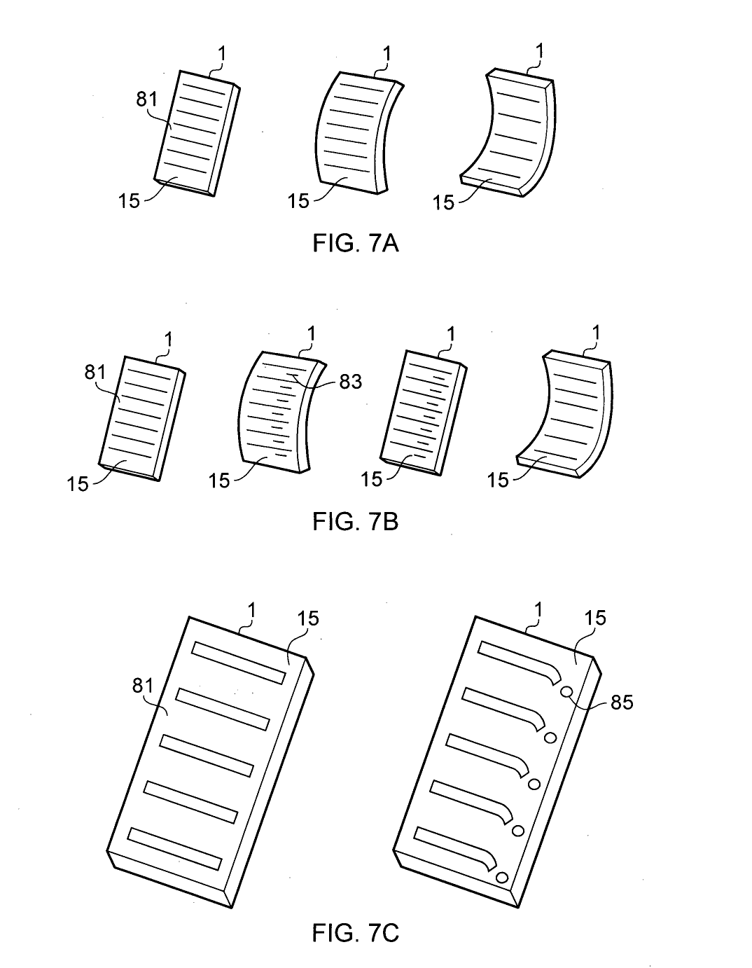

FIGS. 7A to 7C illustrate a third exemplary embodiment of the disclosure; and

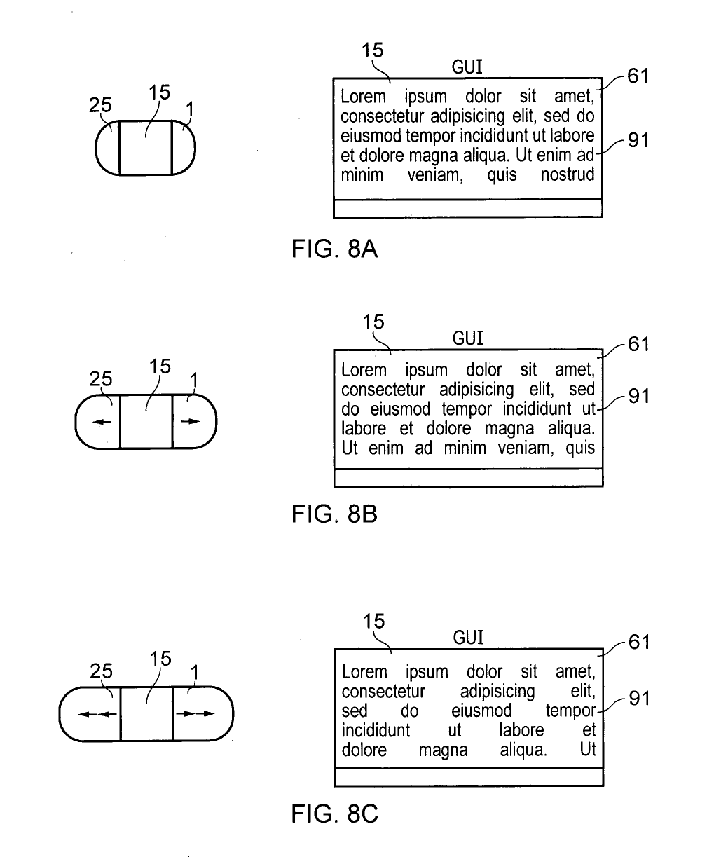

FIGS. 8A to 8C illustrate a third exemplary embodiment of the disclosure.

### DETAILED DESCRIPTION

The Figures illustrate a method, apparatus 1, computer program and user interface wherein the method comprises detecting 51 a user input wherein the user input comprises deforming at least a portion of a housing 25 of an apparatus 1; and in response to detecting the user input, varying 53 the amount of content displayed on a display 15, in dependence upon the deformation made to the housing 25 of the apparatus 1.

FIG. 1 schematically illustrates an apparatus 1 according to an exemplary embodiment of the disclosure. The apparatus 1 may be an electronic apparatus. The apparatus 1 may be, for example, a mobile cellular telephone, a personal computer, a camera, a gaming device, a personal digital assistant, an electronic book reader, a personal music player, a tablet computer or any other similar apparatus. The apparatus 1 may be a handheld apparatus 1 which can be carried in a user's hand, handbag or jacket pocket for example.

Features referred to in the following description are illustrated in FIG. 1. However, it should be appreciated that the apparatus 1 may comprise additional features that are not illustrated. For example, in embodiments of the disclosure where the apparatus 1 is a mobile cellular telephone or other communications device, the apparatus 1 may also comprise one or more transmitters and receivers configured to enable wireless communication.

The apparatus 1 illustrated in FIG. 1 comprises: a user interface 13 and a controller 4. In the illustrated embodiment the controller 4 comprises at least one processor 3 and at least one memory 5 and the user interface 13 comprises a display 15, a user input device 17 and one or more sensors 19. The one or more sensors 19 may be configured to detect physical deformation of the apparatus 1.

The apparatus 1 illustrated in FIG. 1 also comprises a housing 25. The housing 25 provides an external casing for the apparatus 1. The components of the apparatus 1, which are illustrated schematically in FIG. 1 and FIG. 3, may be contained within the housing 25. Some of the components of the apparatus 1, such as the display 15 and the user input device 17 may be provided on the surface of the housing 25. The housing 25 may provide protection for the components of the apparatus 1. For example, the housing 25 may protect the components of the apparatus 1 from atmospheric conditions such as moisture or temperature variations. The housing 25 may also be configured to protect the components of the apparatus 1 from mechanical shocks.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc.) to be executed by such processors 3.

The controller 4 may be configured to control the apparatus 1 to perform a plurality of different functions. For example, where the apparatus 1 is a mobile cellular telephone the controller 4 may be configured to control the apparatus 1 to make and receive telephone calls and also to perform other functions such as send messages or access communication networks such as local area networks or the internet. In some embodiments of the disclosure the apparatus 1 may also be configured to store and render content such as audio and audio visual content.

The controller 4 may also be configured to enable the apparatus 1 to detect a user input wherein the user input comprises deforming at least a portion of a housing 25 of the apparatus 1; and in response to detecting the user input, vary the amount of content displayed on a display 15, in dependence upon the deformation made to the housing 25 of the apparatus 1.

The at least one processor 3 is configured to receive input commands from the user interface 13 and also to provide output commands to the user interface 13. The at least one processor 3 is also configured to write to and read from the at least one memory 5. The outputs of the user interface 13 are provided as inputs to the controller 4.

The at least one memory 5 stores a computer program 9 comprising computer program instructions 11 that control the operation of the apparatus 1 when loaded into the at least one processor 3. The computer program instructions 11 provide the logic and routines that enable the apparatus 1 to perform the methods illustrated in FIG. 4. The at least one processor 3 by reading the at least one memory 5 is able to load and execute the computer program 9.

The computer program instructions 11 may provide computer readable program means configured to control the apparatus 1. The program instructions 11 may provide, when loaded into the controller 4; means for detecting 51 a user input wherein the user input comprises deforming at least a portion of a housing 25 of an apparatus 1; and means for varying 53, in response to detecting 51 the user input, the amount of content displayed on a display, in dependence upon the deformation made to the housing 25 of the apparatus 1.

The computer program 9 may arrive at the apparatus 1 via any suitable delivery mechanism 21. The delivery mechanism 21 may be, for example, a computer-readable storage medium, a computer program product 23, a memory device, a record medium such as a CD-ROM or DVD, an article of manufacture that tangibly embodies the computer program 9. The delivery mechanism may be a signal configured to reliably transfer the computer program 9. The apparatus 1 may propagate or transmit the computer program 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific integration circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

In the exemplary embodiment illustrated in FIG. 1 the user interface 13 comprises a user input device 17, a display 15 and one or more sensors 19.

The user input device 17 may comprise any means which enables a user of the apparatus 1 to input information into the apparatus 1. The information may be used to control the apparatus 1. The information may be stored in the one or more memories 5 of the apparatus 1. The user input device 17 may comprise a touch sensitive display, a keypad a joystick or navigation key or a combination of different types of user input devices.

The display 15 may comprise any means which enables information to be displayed to a user of the apparatus 1. The information may correspond to information which has been input by the user via the user input device 17, information which is stored in the one or more memories 5 or information which has been received by apparatus 1.

In some embodiments of the disclosure the user input device 17 and the display 15 may be combined to provide a touch sensitive display which both enables information to be displayed to a user and enables a user to make user inputs. In some embodiments the display 15 may be configured to provide a hovering user input device whereby a user can make inputs by hovering an input device such as a finger, hand, stylus or any other suitable object in proximity to the surface of the display.

In some embodiments of the disclosure the user interface 13 may also comprise one or more sensors 19. The sensors 19 may be configured to detect contortions and other deformations of the apparatus 1 which are caused by a user applying stress to the housing 25 of the apparatus 1. The sensors 19 may be configured to detect different contortions and deformations and provide an output signal to the controller 4 which enables the controller 4 to determine between the different contortions and deformations. The sensors 19 may also be configured to detect different magnitudes of contortions and deformations. The controller 4 may then control the apparatus 1 in dependence upon the detected deformation.

In some exemplary embodiments of the disclosure the housing 25 of the apparatus 1 may comprise a flexible body portion which may be physically deformed by a user applying stress to the housing 25. The physical deformation may comprise bending, folding, twisting or stretching or other similar deformation of the housing 25 of the apparatus 1 or a portion of the housing 25 of the apparatus 1. Examples of physical deformations of the housing 25 of the apparatus 1 are illustrated in FIGS. 2A to 2D.

In some embodiments of the disclosure the housing 25 may comprise a flexible portion and a rigid portion so that the user can only deform the flexible part of the housing 25. The rigid part of the housing 25 may provide additional protection for sensitive components of the apparatus which may be damaged if deformed. In other embodiments of the disclosure the whole of the housing 25 may be flexible so that a user may be able to deform any part of the housing 25 by applying the appropriate external forces and stress.

The flexible body portion of the housing 25 may comprise a resiliently deformable material that surrounds an inner protective core. The inner protective core may house the controller 4 and other components that may be damaged if bent or deformed. The resiliently deformable material may comprise, for example, a gel or fluid in a sealed sac and/or elastomeric material.

In some embodiments the apparatus 1 may comprise a plurality of hinged or jointed segments. The hinged or jointed segments may be configured to be moved with respect to each other to enable a portion of the apparatus 1 to be folded or bent. The apparatus 1 may be folded or bent in response to a force applied by the user of the apparatus 1.

FIGS. 2A to 2D illustrate an apparatus 1 according to exemplary embodiments of the disclosure. The apparatus 1 comprises a housing 25 and a display 15 located in the outer surface of the housing 25. The other components of the apparatus 1 may be located within the apparatus 1 and so are not illustrated in FIGS. 2A to 2D. In some embodiments of the disclosure the display 15 may also be configured to be deformed with the rest of the housing 25 of the apparatus 1. In other embodiments of the disclosure the display 15 may be rigid so that it does deform and remains substantially the same size and shape when the rest of the housing 25 is deformed.

FIG. 2A illustrates an apparatus 1 in an un-deformed state. In the un-deformed state no stress or external force is being applied to the apparatus 1 by the user and so the housing 25 of the apparatus 1′ is in its normal, un-deformed state. In the particular embodiment illustrated in FIG. 2A the normal, un-deformed state comprises a substantially flat rectangular prism.

FIG. 2B illustrates the apparatus 1 in a first deformed state. In the first deformed state the user has stretched the apparatus 1 by applying a force to the ends of the housing 25 in a direction substantially in parallel to the length of the apparatus 1 as indicated by the arrows 31 and 33. The application of this stress has deformed the apparatus 1 so that the housing 25 is elongated. The housing 25 illustrated in FIG. 2B is still a substantially flat rectangular prism, however the rectangular prism is now longer but narrower than in the un-deformed state.

In some embodiments of the disclosure the increase in the length of the housing 25 may be proportional to the external force or stress applied by the user. By varying the stress applied to the ends of the housing 25 the user can vary the amount of deformation of the housing 25.

FIG. 2C illustrates the apparatus 1 in a second deformed state. In the second deformed state the user has bent the apparatus 1 by applying a substantially downwards force to each end of the housing 25 in the directions indicated by the arrows 35 and 37. The application of these forces has deformed the apparatus 1 so that the housing 25 is now bent or curved.

The amount of bending or curvature of the housing 25 may be proportional to the external force or stress applied by the user. By varying the stress applied to the ends of the housing 25 the user can vary the amount of bending or curvature of the housing 25.

FIG. 2D illustrates the apparatus 1 in a third deformed state. In the third deformed state the user has twisted the apparatus 1 by applying a torque to each end of the housing 25 in the directions indicated by the arrows 39 and 41. The application of these forces has deformed the apparatus 1 so that the housing 25 is now twisted.

The amount of twisting of the housing 25 may be proportional to the external torque applied by the user. By varying the torque applied to the ends of the housing 25 the user can vary the amount of twisting of the housing 25.

It is to be appreciated that the deformations disclosed in FIGS. 2A to 2D are exemplary and that other deformations may be made. For example a user may be able to simultaneously bend and stretch the housing 25 of the apparatus 1. In other embodiments a user may apply a force which causes the compression or folding of the housing 25 of the apparatus 1, for example, the user may apply a force in a direction substantially opposite to the directions indicated by arrows 31 and 33 in FIG. 2B.

Also in the embodiments of the disclosure illustrated in FIGS. 2A to 2D the user has deformed the whole of the housing 25. In other embodiments of the disclosure the housing 25 may be configured so that a user can deform some portions of the housing 25 but leave other portions un-deformed. For example, the user may bend only one end of the housing 25.

FIG. 3 illustrates an apparatus 1′ according to another embodiment of the disclosure. The apparatus 1′ illustrated in FIG. 3 may be a chip or a chip-set. The apparatus 1′ comprises at least one processor 3 and at least one memory 5 as described above in relation to FIG. 1. The apparatus 1′ may be contained within the housing 25.

FIG. 4 illustrates a method according to exemplary embodiments of the disclosure. At block 51 the one or more sensors 19 sense a user input comprising deforming at least a portion of the housing 25 of the apparatus 1. The sensors 19 provide an output signal to the controller 4 so that the controller 4 can detect that the user input has been made.

The deformation may comprise any change in size or shape of the housing 25 of the apparatus 1 in response to an external force applied by the user. The deformation may be made to the whole of the housing 25 or just a portion of the housing 25 of the apparatus 1. For example, the deformation may comprise a stretching, bending or twisting of the housing 25 of the apparatus 1 as illustrated in FIGS. 2B to 2D.

The output signal which is provided to the controller 4 by the one or more sensors 19 may provide an indication of the type of the deformation which has been made. For example it may provide an indication of the change of shape of the housing 25. For instance, it may indicate whether the housing 25 has been stretched or bent or twisted or a combination of different deformations.

The output signal which is provided to the controller 4 by the one or more sensors 19 may also provide an indication of a magnitude of the deformation which has been made. For example it may indicate how far the housing 25 has been stretched or the angle through which the housing 25 has been bent or twisted or the radius of curvature of a bend or twist or any other detectable characteristic which provides an indication of the magnitude of the deformation.

At block 53, in response to detecting the user input, the controller 4 controls the display 15 to vary the amount of content displayed on the display 15. The amount of variation of the content may depend on the deformation made to the housing 25 of the apparatus 1. The type of content which is displayed on the display may depend on factors such as the mode of operation of the apparatus 1, the functions available to the apparatus 1 and the type of deformation which has been made.

In some embodiments of the disclosure varying the amount of content displayed on a display 15 may comprise adding content items to the display 15. In other embodiments of the disclosure varying the amount of content displayed on a display 15 may comprise removing content items from the display 15. Whether content is added or removed may be determined by the deformation which is made to the apparatus 1. For example, bending the housing 25 of the apparatus 1 in a first direction may cause content items to be added to the display 15 while bending the housing 25 of the apparatus 1 in a second, different direction might cause content items to be removed from the display 15.

In some embodiments of the disclosure returning the housing 25 of the apparatus 1 to the un-deformed state may cause the content displayed on the display 15 to be returned to its original state. The apparatus 1 may be returned to its un-deformed state automatically once the user removes the stress or torque applied. In some embodiments of the disclosure the user may need to apply a further external force in the opposite direction to return the housing 25 of the apparatus 1 back to the un-deformed state.

In other embodiments of the disclosure the controller 4 may control the display 15 to fix the content displayed on the display 15 after the deformation input has been detected so that the apparatus 1 may be returned to the un-deformed state without any further variations of the content displayed on the display 15. This may be useful if the user wishes to continue viewing content added to the display 15 but might find it tiring or inconvenient to continue applying the forces necessary to maintain the housing 25 in a deformed state.

The content displayed on the display 15 may depend on the mode of operation of the apparatus 1. The content which is added or removed from the display 15 may depend on the mode of the operation of the apparatus 1 and also the type and/or magnitude of the deformation applied to the housing 25 of the apparatus 1. Exemplary embodiments of the disclosure are illustrated in FIGS. 5 to 8. It is to be appreciated that other embodiments of the disclosure may be implemented.

FIGS. 5A to 5D illustrate a first exemplary embodiment of the disclosure. In this exemplary embodiment the controller 4 controls the display 15 to add user selectable control elements to the display 15 in response to a detection that the housing 25 of the apparatus 1 has been stretched or bent. In the embodiment illustrated in FIGS. 5A to 5D the user may deform the housing 25 of the apparatus 1 by stretching the housing 25 of the apparatus 1 as illustrated in the left hand example or by bending the housing 25 of the apparatus 1 as illustrated in the right hand example or a combination of the two. An example of a graphical user interface 61 which may be displayed on the display 15 is illustrated in the centre. The display 15 may be a touch sensitive display.

In FIG. 5A the apparatus 1 is configured in its normal, un-deformed state. In the un-deformed state no external forces are applied by the user to the housing 25 of the apparatus 1. The housing 25 of the apparatus 1 is a substantially flat rectangular prism.

When the apparatus 1 is in the normal, un-deformed state the graphical user interface 61 which is displayed on the display 15 comprises a plurality of user selectable control elements 63A to 63L. The plurality of user selectable control elements 63A to 63L may comprise part of a home screen or a menu structure. In the exemplary embodiment illustrated in FIGS. 5A to 5D the user selectable control elements are associated with the functions of calendar 63A, contacts 63B, music 63C, web 63D, messaging 63E, photos 63F, store 63G, map 63H, video 631, setting 63J, social 63K and applications 63L. It is to be appreciated that in other embodiments of the disclosure other control elements may be associated with different functions and sets of functions.

Each of the user selectable control elements comprises an icon. A user may access the functions, content and applications associated with the control elements 63A to 63L by actuating the area of the display 15 in which the respective user selectable control element 63A to 63L is displayed.

In FIG. 5B the user has made a user input comprising deforming the housing 25 of the apparatus 1. This may have been by stretching the housing 25 of the apparatus 1 to elongate the housing 25 or by bending the housing 25 of the apparatus 1 so that the housing is curved rather than substantially flat.

In response to determining that the user input has been made the controller 4 controls the display 15 to add a plurality of additional user selectable control elements 65A to 65L to the graphical user interface 61. In the embodiment of FIG. 5B an additional user selectable control element 65 is displayed for each of the original user selectable control elements 63 previously displayed on the display 15 when the apparatus 1 was in the normal, un-deformed state. In the specific embodiment of FIGS. 5A to 5B the additional user selectable control elements 65 are displayed overlaying the original user selectable control elements 63.

Each of the additional user selectable control elements 65 provides a shortcut to a specific function or piece of content associated with the respective applications. The function or content may be, for example, the most recent function or content used by the user in that application or it may be the most frequently used or a function or piece of content which the user has selected to be associated with the shortcut. For example, the additional user selectable control element 65A associated with the calendar application may provide a shortcut to the next entry in the calendar. The additional user selectable control element 65B associated with the contact application may provide a shortcut to details of a contact stored within the contact application. The additional user selectable control element 65C associated with the music application may provide a shortcut to the last song or audio file which was played. The additional user selectable control element 65D associated with the web application may provide a link to a web page selected or recently accessed by the user. The additional user selectable control element 65E associated with the messaging application may provide access to the most recently received message or may enable a user to write a new message. The additional user selectable control element 65F associated with the photos application may provide a shortcut to a recently captured image or an album of images. The additional user selectable control element 65G associated with the store application may enable a user to access the most popular applications available from the store. The additional user selectable control element 65G associated with the maps application may enable a user to identify their current location. The additional user selectable control element 651 associated with the video application may provide a shortcut to a recently captured or viewed video. The additional user selectable control element 65J associated with the settings may provide a shortcut to specific setting of the apparatus 1 such as the profiles or themes of the apparatus. The additional user selectable control element 65K associated with the social application may provide a shortcut to the profile of a contact from the social application. The additional user selectable control element 65L associated with the applications may provide a shortcut to a recently used or downloaded application. It is to be appreciated that the above mentioned functions are exemplary and other functions, applications and content may be used in other embodiments of the disclosure. The user of the apparatus 1 may be able to access any of the functions or content associated with the additional user selectable control elements 65A to 65L by actuating the area of the display 15 in which the respective control elements are displayed.

In FIG. 5C the user has made a further user input comprising deforming the housing 25 of the apparatus 1 so that the magnitude of the deformation of the housing 25 is increased with respect to the deformation of FIG. 5B. In embodiments where the housing 25 of the apparatus 1 has been stretched the housing 25 in FIG. 5C is longer than the housing in FIG. 5B. In embodiments where the housing 25 has been bent the housing 25 has a greater radius of curvature or bends through a greater angle than in FIG. 5B.

In response to determining that the user input has been made and the magnitude of the deformation has increased the controller 4 controls the display 15 to add a further plurality of user selectable control elements 67A to 67L to the graphical user interface 61 in addition to the plurality of user selectable control elements 65A to 65L displayed in FIG. 5B. The newly added plurality of user selectable control elements 67A to 67L may provide shortcuts to further functions and content associated with the respective applications.

In FIG. 5D the user has made a further user input comprising deforming the housing 25 of the apparatus 1 so that the magnitude of the deformation of the housing 25 is increased with respect to the deformation of FIG. 5B and FIG. 5C. In embodiments where the housing 25 of the apparatus 1 has been stretched the housing 25 in FIG. 5D is longer than the housing in FIGS. 5B and 5C. In embodiments where the housing 25 has been bent the housing 25 has a greater radius of curvature or bends through a greater angle than in FIGS. 5B and 5C.

In response to determining that the user input has been made and the magnitude of the deformation has increased even further the controller 4 controls the display 15 to add a further plurality of user selectable control elements 69A to 69L to the graphical user interface 61 in addition to the plurality of user selectable control elements 65A to 65L and 67A to 67L displayed in FIGS. 5B and 5C. The newly added plurality of user selectable control elements 69A to 69L may provide shortcuts to even more functions and content associated with the respective applications.

This enables a user to easily and conveniently access functions of the apparatus 1. By deforming the housing 25 of the apparatus 1 the user can easily obtain access to the shortcuts provided by the additional user selectable control elements. Also the apparatus 1 is intuitive for a user to use as the further the user deforms the apparatus 1, the more shortcuts are displayed on the display 15.

In some embodiments of the disclosure once the user returns the housing 25 of apparatus 1 to the normal, un-deformed state the additional user selectable control elements may be removed from the display 15. This may enable a user to quickly and easily return to the home screen or menu structure. In other embodiments of the disclosure the user may be able to control the apparatus to fix the additional user selectable control elements onto the display 15 so that the additional user selectable control elements remain displayed on the display 15 even when the apparatus 1 has been returned to the normal, un-deformed state. This may make it easier for a user select the respective shortcuts without having to maintain an external force on the apparatus in order to keep the housing 25 of the apparatus 1 in a deformed state.

FIG. 6 illustrates a second exemplary embodiment of the disclosure. In this exemplary embodiment of the disclosure the controller 4 initially controls the display 15 to display a content item such as an image 71. The image 71 may be an image which is stored in the one or more memories 5 of the apparatus 1 or an image which the apparatus 1 has accessed using a communications function such as an internet or social networking function.

In the initial state the housing 25 of the apparatus 1 may be configured in a normal, un-deformed state. The image 71 may be displayed on the display 15 so that the image occupies the maximum amount of space available on the display 15.

The user then makes a user input comprising applying an external force to the housing 25 of the apparatus 1 which causes deformation of the housing 25 of the apparatus 1. The deformation may be stretching the housing 25 of the apparatus 1 by applying a force in the directions indicated by the arrows 73, 75. However it is to be appreciated that any suitable deformation which could be detected by the one or more sensors 19 may be made.

In response to detecting that the user input has been made the controller 4 controls the display 15 to add content to the display 15. In the embodiment of FIG. 6 the content comprises metadata associated with the image 71 which was originally displayed on the display 15. The metadata 77 may be contextual metadata 77 which indicates the location and time the image was created, the size of the image and whether or not the image has been shared, for example by being uploaded to social networking sites or shared using a messaging application. The metadata might also include comments and titles which have been added by the user of the apparatus 1 or other people with which the image 71 has been shared.

In the particular embodiment illustrated in FIG. 6 when the metadata 77 is displayed on the display the image 71 is also displayed at a reduced scale so that the user can easily see which image the metadata relates to.

The user can return the apparatus 1 to the normal, un-deformed state by removing the application external force from the housing 25 of the apparatus 1. In some embodiments of the disclosure the user may need to apply a force in the opposite direction to the force used to deform the apparatus 1 in order to return the housing 25 of the apparatus 1 to the normal, un-deformed state.

Once the controller 4 determines that the housing 25 of the apparatus 1 has been returned to the normal, un-deformed state the controller 4 controls the display 15 to remove the metadata 77 from the display 15 and display the image 71 in the original scale.

This enables a user of the apparatus 1 to quickly and easily access metadata associated with content. The content could be any suitable content such as images or video content or text. The apparatus 1 is intuitive for a user to use as deforming the apparatus 1 causes the additional metadata 77 to be added to the display 15 and returning the housing 25 of the apparatus 1 to the un-deformed state removes the additional metadata from the display 15.

FIGS. 7A to 7C illustrate a third exemplary embodiment of the disclosure. In this embodiment of the disclosure a plurality of content items are displayed as a list 81, the plurality of content items may comprise, for example a list of contacts or a list of calendar entries or a list of received messages or any other suitable list of information or functions associated with the apparatus 1.

FIG. 7A illustrates an example in which the user can increase or decrease the number of items from the list 81 which are simultaneously displayed on the display 15 by deforming the housing 25 of the apparatus 1. The number of items of the list 81 displayed simultaneously on the display 15 is increased when the user deforms the housing 25 of the apparatus 1 by bending the ends of the apparatus 1 away from them so that they view a convex display 15. The scale of the items in the list 81 may be decreased so that more items of the list 81 may be displayed simultaneously.

Conversely the number of items of the list 81 displayed simultaneously on the display 15 is decreased when the user deforms the housing 25 of the apparatus 1 in the opposite direction by bending the ends of the apparatus 1 towards them so that they view a concave display 15. The scale of the items in the list 81 may be increased as less items of the list 81 are displayed simultaneously.

FIG. 7B illustrates an example in which the user can control the apparatus 1 to cause additional content relating to the list 81 to be displayed on the display 15. In FIG. 7B the user deforms the housing 25 of the apparatus 1 by bending the ends of the apparatus 1 away from them so that they view a convex display 15. This causes the controller 4 to add additional items 83 to the display 15. In the embodiments of FIG. 7B the additional items 83 are displayed between the previously displayed items in the list 81. The additional items 83 may comprise additional information about the items in the list 81. For example where the items in the list 81 are names of contacts the additional items 83 may comprise further information relating to the contacts such as status updates or details about recent communications between the user of the apparatus 1 and the respective contacts.

In the embodiment of FIG. 7B the user may be able to control the apparatus to fix the additional items 83 on the display 15 so that the user can return the apparatus to the normal, un-deformed state and still view the additional items. This may make the apparatus 1 easier for a user to use as they do not need to maintain the external forces on the housing 25 of the apparatus 1 in order to continue viewing the additional items 83.

In order to remove the additional items 83 from the display 15 the user may need to deform the apparatus 1 in the opposite direction by bending the ends of the apparatus 1 towards them so that they view a concave display 15. This may cause the list 81 to be returned to its original state.

FIG. 7C illustrates an example in which the user can also control the apparatus 1 to cause additional content relating to the list 81 to be displayed on the display 15. In the embodiment of FIG. 7C the user deforms the housing 25 of the apparatus 1 by bending a side of the apparatus 1 away from them so that they view a convex display 15. This causes the controller 4 to add additional items 85 to the display 15. In the embodiments of FIG. 7C the additional items 85 are displayed to the side of the previously displayed items in the list 81. The additional items 85 may comprise additional information about the items in the list 81 or an image or status indication associated with the items in the list 81.

The embodiments illustrated in FIG. 7C enables a user to control which additional items are added to the display 15 by bending the housing 25 of the apparatus 1 in a different direction to the example of FIG. 7B. This may provide a simple and intuitive method of enabling the user to access different content items. In some embodiments of the disclosure the user may be able to cause different content items to be added to the display 15 in response to different deformations of the housing 25 of the apparatus 1.

FIGS. 8A to 8C illustrate a fourth exemplary embodiment of the disclosure. In this embodiment a portion of text 91 is displayed on the display 15. The portion of text 91 may comprise text which is stored in the one or more memories 5 of the apparatus 1 or text which has been received by the apparatus 1.

In this exemplary embodiment the controller 4 controls the display 15 to control the spacing of the text 91 in response to a detection that the housing 25 of the apparatus 1 has been deformed. As the spacing of the text is changed this causes the amount of text displayed on the display 15 to be varied as well.

In the exemplary embodiment illustrated in FIGS. 8A to 8C the user may deform the housing 25 of the apparatus 1 by stretching the housing 25 of the apparatus 1 as illustrated in the schematic illustration of the housing 25 of the apparatus 1. It is to be appreciated that other types of deformations of the housing 25 may be made in other embodiments of the disclosure. An example of a graphical user interface 61 which may be displayed on the display 15 is illustrated adjacent to the schematic illustration of the housing 25 of the apparatus 1.

In FIG. 8A the apparatus 1 is configured in its normal, un-deformed state. In the un-deformed state no external forces are applied by the user to the housing 25 of the apparatus 1 and the housing 25 of the apparatus 1 is a substantially flat rectangular prism.

When the apparatus 1 is in the normal, un-deformed state the graphical user interface 61 which is displayed on the display 15 comprises a portion of text 91 which has a first spacing between each of the letters and words.

In FIG. 8B the user has made a user input comprising deforming the housing 25 of the apparatus 1. In the exemplary embodiment of FIG. 8B the deformation may have been by stretching the housing 25 of the apparatus 1 to elongate the housing 25.

In response to determining that the user input has been made the controller 4 controls the display 15 to change the spacing between the letters and words of the text 91 so that the portion of text 91 is now displayed with a second spacing. In the particular embodiment of FIG. 8B the spacing has increased. As the size of the display 15 has remained the same the amount of content displayed on the display 15 has decreased because there is less text on the display 15 in FIG. 8B than in FIG. 8A.

In FIG. 8C the user has made a further user input comprising deforming the housing 25 of the apparatus 1 so that the magnitude of the deformation of the housing 25 is increased with respect to the deformation of FIG. 8B. In embodiments where the housing 25 of the apparatus 1 has been stretched the housing 25 in FIG. 8C is longer than the housing in FIG. 8B.

In response to determining that the user input has been made and the magnitude of the deformation has increased the controller 4 controls the display 15 to make a further change to the spacing between the letters and words of the text 91 so that the portion of text 91 is now displayed with a third spacing. In the particular embodiment of FIG. 8C the spacing has increased even further. As the size of the display 15 has remained the same the amount of content displayed on the display 15 has decreased because there is less text on the display 15 in FIG. 8C than in FIGS. 8B and 8A.

The embodiment of FIG. 8A to 8C enables a user to easily control the spacing of text 91. This may enable a user to arrange the text into a spacing which is easiest for them to read.

In the particular embodiment illustrated in FIGS. 8A to 8C only the spacing between the letters and words of the text has changed. The size of the individual characters of the text has not changed. In other embodiments of the disclosure both the spacing of the text and the scale of the text may be varied.

Also in some embodiments of the disclosure the spacing between letters may be dependent upon the number of letters in a word. For example, the spacing between letters may be larger for words with a large number of letters than words with a small number of letters.

It is also to be appreciated that in other embodiments of the disclosure a user may be able to decrease the spacing of the text 91 by making appropriate user inputs. For example the user may compress or fold the housing 25 to decrease the spacing.

The blocks illustrated in the FIG. 4 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some blocks to be omitted.

Although embodiments of the present disclosure have been described in the preceding paragraphs with reference to various examples, it should be appreciated that modifications to the examples given can be made without departing from the scope of the disclosure as claimed. For example in some of the above described embodiments the content which is added or removed from the display 15 is determined by the mode of operation of the apparatus 1 and the content which is currently displayed on the display 15 when the user input comprising the deformation is made. In some of the above described embodiments the content which is added or removed is associated with the content which was previously displayed on the display. For example, in the embodiments illustrated in FIGS. 5A to 5D the content which is added is directly connected to the content previously displayed on the display 15 as the added content comprises a user selectable control element which provides access to a function where the function is a subset of the functions which were accessible via the user selectable control elements originally displayed on the display 15.

Conversely in some of the other embodiments described above the content which is added or removed from the display 15 might not be dependent on the mode of operation of the apparatus 1. In such embodiments the user input of deforming the apparatus 1 might cause the same function to be performed irrespective of the initial mode of operation of the apparatus 1. For example, in the embodiments of FIGS. 8A to 8C the user input comprising deforming the housing 25 of an apparatus 1 causes a change in the spacing of characters displayed on the display 15. The same function could be performed if a user is viewing a block of text or a number of items in a list or any other content comprising distinct characters or items.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the disclosure believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
enabling a plurality of user selectable control elements to be displayed,
detecting a user input wherein the user input comprises deforming at least a portion of a housing of an apparatus; and
in response to detecting the user input, enabling at least one additional user selectable control element to be displayed for at least one of the plurality of user selectable control elements previously displayed on the display, in dependence upon the deformation made to the housing of the apparatus.

2. A method as claimed in claim 1 wherein the housing comprises an external casing of the apparatus.

3. A method as claimed in claim 1 wherein the user input comprises applying stress to the housing of the apparatus to cause the deformation.

4. A method as claimed in claim 1 wherein the deformation comprises at least one of bending at least a portion of the housing of the apparatus, or stretching at least a portion of the housing of the apparatus.

5-7. (canceled)

8. A method as claimed in claim 1 wherein the number of additional user selectable control elements displayed is dependent upon a magnitude of the deformation.

9. A method as claimed in claim 1 wherein returning the apparatus to an un-deformed state causes the additional user selectable control elements displayed on the display to be removed from the display.

10. A method as claimed in claim 1 further comprising controlling the display to fix the content displayed on the display so that returning the apparatus to an un-deformed state does not remove the additional user selectable control elements from the display.

11-15. (canceled)

16. An apparatus comprising:
at least one processor; and
at least one memory including computer program code;
wherein the at least one memory and the computer program code are configured to, with the at least one processor, enable the apparatus to:
enable a plurality of user selectable control elements to be displayed,
detect a user input wherein the user input comprises deforming at least a portion of a housing of the apparatus; and
in response to detecting the user input, enable at least one additional user selectable control element to be displayed for each user selectable control element previously displayed on the display, in dependence upon the deformation made to the housing of the apparatus.

17. An apparatus as claimed in claim 16 wherein the housing comprises an external casing of the apparatus.

18. An apparatus as claimed in claim 16 wherein the user input comprises applying stress to the housing of the apparatus to cause the deformation.

19. An apparatus as claimed in claim 16 wherein the deformation comprises at least one of bending at least a portion of the housing of the apparatus, or stretching at least a portion of the housing of the apparatus.

20-22. (canceled)

23. An apparatus as claimed in claim 16 wherein the number of additional user control elements displayed is dependent upon a magnitude of the deformation.

24. An apparatus as claimed in claim 16 wherein the at least one memory and the computer program code are configured to, with the at least one processor, cause the additional user selectable control elements displayed on the display to be removed in response to detecting that the apparatus is returned to an un-deformed state.

25-30. (canceled)

31. A non-transitory physical entity comprising computer program comprising computer program instructions that, when executed by at least one processor, cause an apparatus at least to perform:
enabling a plurality of user selectable control elements to be displayed,
detecting a user input wherein the user input comprises deforming at least a portion of a housing of an apparatus; and
in response to detecting the user input, enabling at least one additional user selectable control element to be displayed for each user selectable control element previously displayed on the display, in dependence upon the deformation made to the housing of the apparatus.

32-38. (canceled)

39. A method as claimed in claim 1 wherein each user selectable control element is associated with an application so that the user selectable control element provides a shortcut to at least one of a function associated with an application or a content item associated with the application.

40. A method as claimed in claim 39 wherein the additional user selectable control elements comprise at least one of the most recently used shortcut, or the most frequently used shortcut.

41. A method as claimed in claim 1 wherein at least one additional user selectable control element is provided for each user selectable control element previously displayed on the display.

42. An apparatus as claimed in claim 16 wherein each user selectable control element is associated with an application so that the user selectable control element provides a shortcut to at least one of a function associated with an application or a content item associated with the application.

43. An apparatus as claimed in claim 16 wherein the additional user selectable control elements comprise at least one of the most recently used shortcut or the most frequently used shortcut.

44. An apparatus as claimed in claim 16 wherein at least one additional user selectable control element is provided for each user selectable control element previously displayed on the display.
